(19) United States
(12) Patent Application Publication
(10) Pub. No.: US 2007/0287127 A1
(43) Pub. Date: Dec. 13, 2007

(54) Screw retention system for use with a dental instrument

(76) Inventors: Allan Schaffran, Toronto (CA); Andy Doug-Lun Wong, Toronto (CA); Robert G. Dickie, King City (CA)

Correspondence Address: SAND & SEBOLT, AEGIS TOWER, SUITE 1100, 4940 MUNSON STREET, NW, CANTON, OH, 44718-3615, US

(21) Appl. No.: 11/446,700

(22) Filed: Jun. 5, 2006

(51) Int. Cl. A61C 1/10

(52) U.S. Cl. 433/114

(57) ABSTRACT

A retention system connects a dental instrument to a dental component and maintains contact between them during installation of the latter in the oral cavity. The instrument includes a shaft having a shaped driver bit at one end. The dental component includes a head configured to be engaged by the driver bit, a shank that extending outwardly away from the head and a plurality of threads thereon. In a first embodiment, the system includes a clip that is frictionally engaged with the shaft of the instrument and snap fitted to the head of the dental component. In a second embodiment, the system includes a vacuum source operationally connected to a passageway in the dental instrument. A vacuum is generated at the driver bit tip which retains the dental component on the instrument.

### BACKGROUND OF THE INVENTION

1. Technical Field

This invention generally relates to dental instruments. More particularly, the invention relates to an instrument used for installing dental components relating to artificial teeth. Specifically, the invention relates to a screw retainer for maintaining contact between threaded prostheses and the dental instruments used to install the same.

2. Background Information

The advent of implant prosthodontics has brought about a paradigm shift in the way dentists secure artificial teeth in the oral cavity. In the early 1980's much of the fixed-detachable bridgework for full arch dental rehabilitation and restoration was attached by means of some type of retaining screw. Depending on the implant system used, the screws were torqued by hand to effect the clamping force necessary for retaining the implant in the jaw bone. Therefore, one of the early prosthetic complications was screw loosening that was caused by lack of initial pre-load of the screw, as well as poor fit and heavy bite forces.

As the industry moved forward in the early 1990's, single tooth and partially endentulous applications became commonplace. Torque wrenches were introduced with or without torque controllers. Screw loosening was significantly reduced by utilizing torque values anywhere from 15-35 Ncm and changing the screw composition from gold to alloyed materials. Two retention philosophies grew out of the new protocol, firstly, screw-retained fixed implant prostheses that may involve one or more abutment and retention screws and, secondly, cement-retained prostheses that usually have an abutment screw under one or more cemented crowns.

There are many competing implant systems currently available on the market for installing the retention and abutment screws and each system has its own unique features. There are different size implant bolts, abutment screws, thread orientations and screw-head driving types. Each manufacturer tends to produce their own types of screwdrivers and torque wrenches for installing and tightening their own particular components. The wrenches and screwdrivers generally cannot be used for universal installation of these components. One of the more popular torque wrench systems on the market today is manufactured by Dentsply International, based out of York, Pennsylvania. Dentsply International manufactures, amongst other products, both a torque screwdriver hub and a ratchet driver for loading dental components.

The steps to install and torque a retainer screw are typically as follows:

A cylindrical hole is drilled into the alveolar ridge of the patient and an implant bolt is inserted into that cylindrical hole. The implant bolt typically includes an external thread that allows it to bite into and grip the surrounding bone. The implant bolts generally also include an internally threaded bore that is adapted to receive a male portion of a prosthesis, i.e., an artificial tooth or a post for an artificial tooth. Once the implant bolt is installed in the jaw bone, it is covered and a period of time is allowed to pass so that the implant undergoes osseointegration, i.e., bone tissue infiltrates and surrounds the implant bolt to securely embed the same within the jaw bone. After this has occurred, the prosthesis is installed. This is accomplished as follows:
1. A screw is placed on the end of a small manual screwdriver. The prosthesis is inserted into position with respect to the implant bolt. The screw is placed into a hole on the prosthesis and the dentist tries to hold the screw and prosthesis on the implant bolt with one finger and with the other hand tries to line up and begin to engage the threads on the screw.
2. Once the screw is started and there is no danger of dropping the screw and prosthesis, the dentist will use a speed wrench to turn the screw. A speed wrench is a 90° screwdriver with a rotary knob on its outer end that allows the dentist to turn the screw the required number of turns until it seats.
3. Once the screw has been seated with the speed wrench, the dentist will change his tool and will use a torque wrench to engage and properly tighten the screw according to the manufacturer's specifications.

One of the main problems that dentists encounter in installing retaining screws is the limited access that the dentist has to various areas of the mouth, such as the rear molar region. The screws involved are typically around % inch long and the installation must be started by hand with a tiny hand-held screwdriver which is about 4 inches long. The dentist is always concerned that the screw will disengage from the dental instrument before the threads are adequately secured into the jaw bone or implant bore and that the patient will accidentally ingest the components being installed. It is therefore commonplace for the dentist to put a cloth in the back of the patient's mouth in order to try and catch and retrieve any accidentally dislodged components. It has been noted by the present inventors that these components tend to fall out during initial thread capture approximately 20% of the time. The fall-out rate is dependent upon the manual skills and experience of the dentist. Many dentists use various tricks in an attempt to try and keep the screws on the dental instrument during initial installation. Such tricks have included the use of wax and other sticky materials to retain the screws on the driver bit of the dental instrument. There has been speculation that these materials can, however, compromise the torque settings.

There is therefore a need in the art for a retainer system that maintains contact between the driver bit of a dental instrument and the dental component being installed thereby.

### SUMMARY OF THE INVENTION

The retention system of the present invention selectively attaches a dental instrument to a dental component and serves to maintain contact between the instrument and component during installation of the latter in the oral cavity of a patient. The dental instrument includes a shaft that has a shaped driver bit at one end. The dental component includes a head that is configured to be engaged by the driver bit. A shank extends outwardly away from the head of the dental component and has a plurality of threads formed on at least a portion thereof. In a first embodiment of the invention, the retention system comprises a clip that is frictionally engaged around the shaft of the dental instrument and is snap fitted to the head of the dental component. In a second embodiment of the invention, the retention system comprises a vacuum source that is operationally connected to a passageway formed in the dental instrument and generates a vacuum at the tip of the driver bit. The retention system thereby retains the dental component to the dental instrument by suction. When the vacuum source is deactivated, the suction ceases and the dental component is released from the instrument.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is an exploded side view of a dental instrument and a first embodiment of a retention system, namely a retention clip, in accordance with the present invention;

FIG. 2 is a side view of the dental instrument and dental component connected together by the retention clip of the present invention;

FIG. 3 is a cross-sectional side view of FIG. 2;

FIG. 4 is a top view of the dental instrument of FIG. 1;

FIG. 5 is an exploded side view of a dental instrument and a second embodiment of a retention clip in accordance with the present invention;

FIG. 6 is a side view of the dental instrument and dental component connected together by the retention clip of FIG. 5;

FIG. 7 is a cross-sectional side view of FIG. 6;

FIG. 8 is a perspective view of a dental instrument including a second embodiment of a dental component retention system in accordance with the present invention;

FIG. 9 is a side view of the dental instrument and dental component shown in FIG. 8;

FIG. 10 is a top view of the dental instrument of FIG. 8;

FIG. 11 is a cross-sectional side view of the dental instrument through line A-A of FIG. 10;

FIG. 12 is a perspective view of a dental instrument in accordance with the present invention and showing a finger retainer for holding the device;

FIG. 13 is an exploded perspective view of the dental instrument as shown in FIG. 12;

FIG. 14 is a cross-sectional front view of the dental instrument and dental component; and

FIG. 15 is a cross-sectional side view through line B-B of FIG. 14.

### DETAILED DESCRIPTION OF THE INVENTION

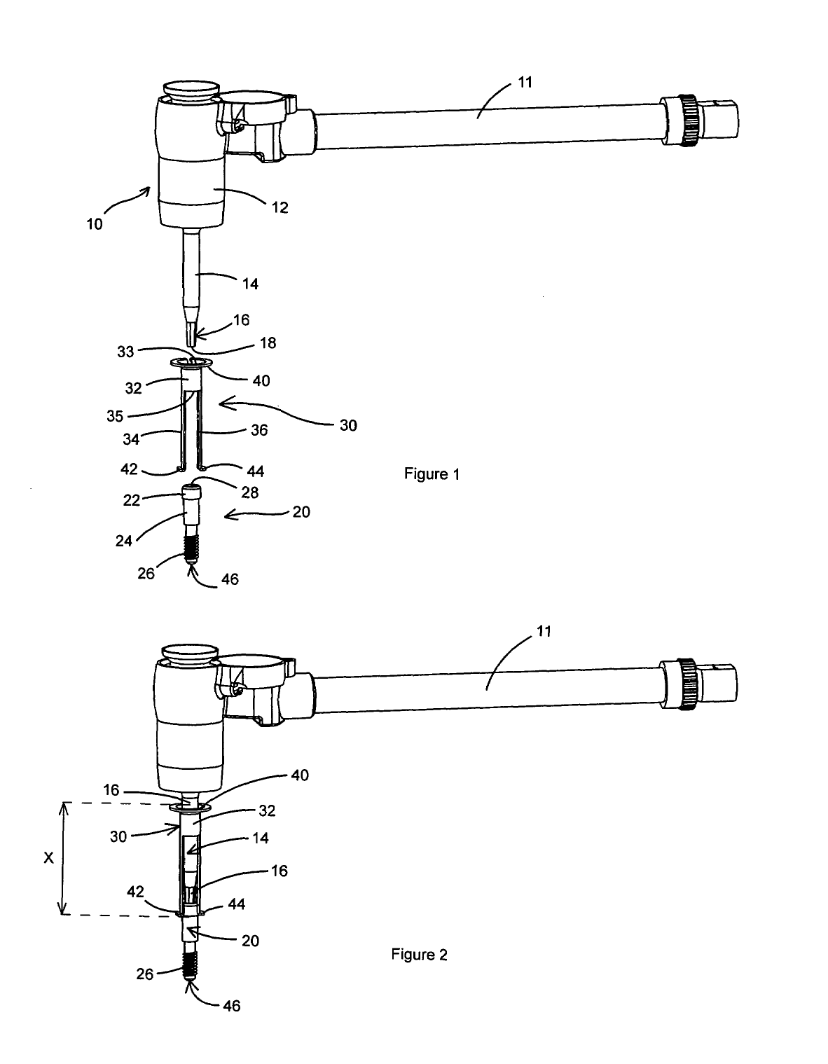

Referring to FIGS. 1-4, there is shown a dental instrument, being a screwdriver 10, that includes a body 12, an elongated shaft 14 and a driver bit 16. A handle 11 is provided to aid in manipulating body 12. Driver bit includes a tip 18 that is shaped to engage the head of a dental component. Screwdriver 10 illustrated in these figures has an integrally formed body, shaft 14 and driver bit 16, but any suitable dental screwdriver 10 may be used in conjunction with the retainer of the present invention as described hereafter. Screwdriver 10 may form part of a torque wrench, may include a finger-rotatable barrel that causes shaft 14 and bit 16 to rotate or the rotation of body 12, shaft 14 and bit 16 may be motor driven. The exact nature of screwdriver 10 does not form part of this application.

The dental component illustrated in FIGS. 1-4 is an implant bolt 20 that has a head 22 and a shank 24. A portion of shank 24 includes a plurality of threads 26 that enable implant bolt 20 to bite into the jaw bone (not shown) of a patient. Implant bolt 20 also has a bore 28 for receiving a male portion of an artificial tooth or of an abutment therein. Implant bolts 20 are well known in the art and the retainer of the present invention may be used with any one of these dental components. Head 22 of implant may be therefore provided with an external hexagonal shape, internal hexagonal shape or any other shape to be engaged by a complementary sized and shaped driver bit 16.

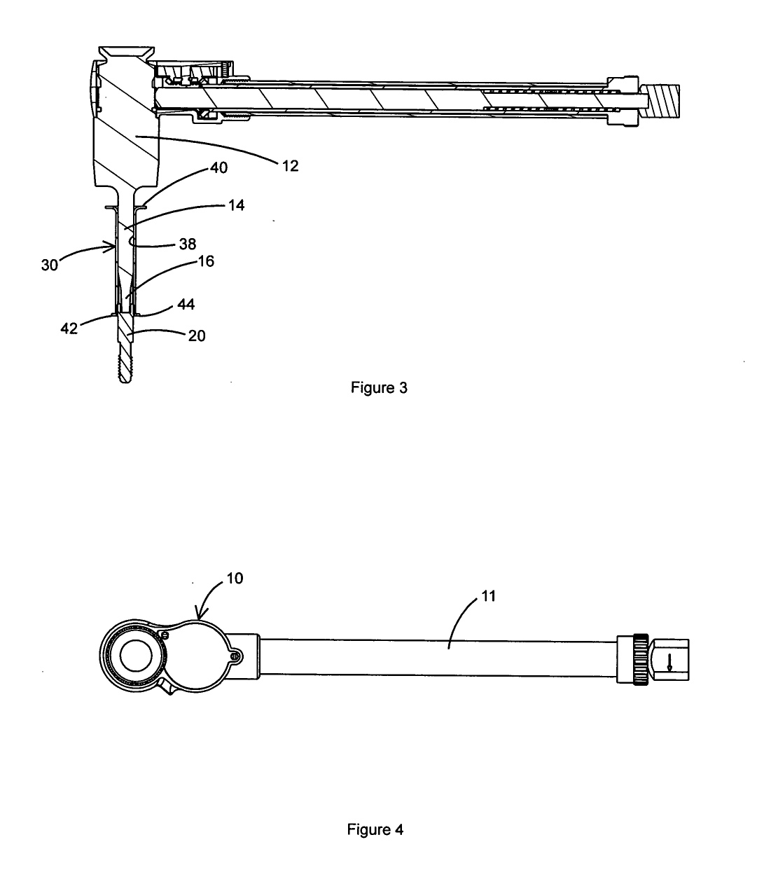

In accordance with a specific feature of the present invention, there is provided a retainer for maintaining contact between driver bit 16 and implant bolt 20. The retainer comprises a clip 30 made from very thin, spring stamped stainless steel. Clip 30 includes a tubular member 32 at a first end and a pair of spaced apart flexible fingers 34, 36 at a second end. Tubular member 32 includes an axial bore 38 (FIG. 3) that is sized to frictionally engage and receive shaft 14 and driver bit 16 of screwdriver 10 therethrough. Tubular member 32 preferably is provided with an annular flange 40 that aids the dentist in gripping clip 30 and which can act as a stop to prevent clip 30 from riding too far up shaft 14. Tubular member 32 preferably is also provided with a longitudinal slot 33 (FIG. 1) therein which extends from annular flange 40 through to an end 35 thereof. FIG. 3 shows that retainer clip 30 preferably is a unitary and integrally formed component.

Flexible fingers 34, 36 are spaced a distance apart from each other that is very slightly less than the external diameter of head 22 of implant bolt 20. Fingers 34, 36 terminate in flanges 42, 44 that aid the dentist in gripping clip 30, and may also act as a stop to prevent implant bolt 20 from being driven too far into the jaw bone. Fingers 34, 36 flex away from each other to receive head 22 of implant bolt 20 therebetween.

In use, the dentist will grasp tubular member 32 of clip 30 and force fingers 34, 36 over head 22 of implant bolt 20. In some instances, fingers 34, 36 may also engage at least an upper portion of shank 24 of implant bolt 20. Fingers 34, 36 essentially snap fit around head 22 and secure implant bolt 20 and clip 30 together. The combined clip 30 and implant bolt 20 are then engaged with screwdriver 10 by inserting tip 18 of driver bit 16 into bore 38 of clip 30 and sliding clip 30 along shaft 14 toward body 12. Clip 30 is slid along shaft 16 until the tip 18 of driver bit 16 engages head 22 of implant bolt 20. Screwdriver 10 and clip 30 may be slightly rotated to ensure that the shaped driver bit 16 is firmly engaged with the complementary shaped head 22 of implant bolt 20. As may be seen from FIG. 2, clip 30 has a length “X” that is shorter than the combined length of shaft 14 and driver bit 16, so that clip 30 slides up shaft 16 but does not engage the body 12 of screwdriver 10. Consequently, clip 30 is secured to both screwdriver 10 and implant bolt 20 and prevents accidental separation thereof. Clip 30 also maintains contact between driver bit 16 and head 22 of implant bolt 20.

Implant bolt 20 is inserted into a pre-drilled hole (not shown) in the patient's jaw bone by placing the tip 46 of implant bolt 20 into the hole. Shaft 14 and therefore driver bit 16 are rotated and thereby rotate implant bolt 20 so that threads 26 on shank 24 bite into the patient's jaw bone. When threads are sufficiently engaged with the jaw bone that implant bolt 20 will not slip out of the hole, then the dentist can remove clip 30. This is accomplished by raising screwdriver 10 sufficiently to allow clip 30 to disengage from shaft 14. At this point, clip 30 is still in engagement with implant bolt 20. The dentist then grasps tubular member 32 and pulls upwardly to disengage fingers 34, 36 from head 22 of implant bolt 20. Clip 30 can then be set aside for subsequently sterilization. At this point, the tip 18 of driver bit 16 may be engaged once again with head 22 to finish installing implant bolt 20.

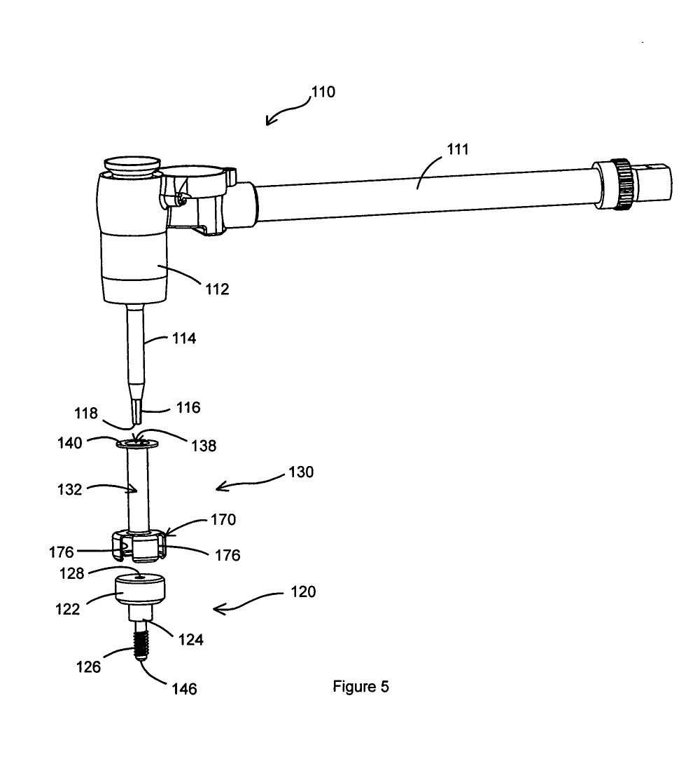

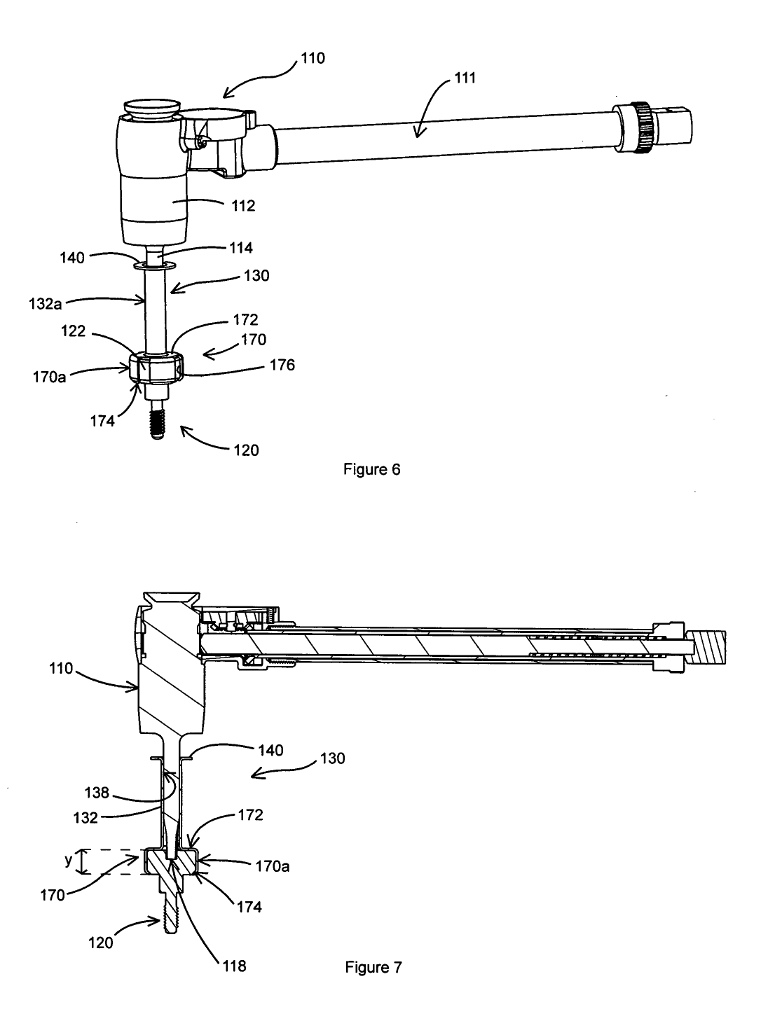

A second embodiment of retainer is shown in FIGS. 5-7. In these figures, the dental component is an abutment screw that generally indicated at 120. Screw 120 has a head 122 and a shank 124, with a plurality of threads 126 being provided on at least a portion of the shank. Screw 120 further includes a bore 128 in head 122 that is configured to engage the driver bit 116 on screwdriver 110. As with the previous screwdriver, screwdriver 110 includes a shaft 114, a body 112 and a handle 111.

In accordance with a specific feature of the present invention, retainer clip 130 is provided to maintain contact between driver bit 116 and head 122 of screw 120 during installation. Retainer clip 130 comprises an elongated tubular member 132 having an annular flange 140 provided at a first end and a housing 170 provided at a second end thereof. An axial bore 138 extends through clip 130 and is sized to frictionally engage shaft 114 of screwdriver 110. Flange 140 is of a greater diameter than tubular member 132 and is provided to aid the dentist in gripping clip 130 during insertion and removal and to also act as a stop.

Referring to FIG. 7, housing 170 has a peripheral side wall 170a that is concentric with the outer wall 132a of tubular member 132. The diameter of side wall 170a is greater than the diameter of outer wall 132a. Housing 170 also has an upper annular flange 172 and a lower annular lip 174. The distance between flange 172 and lip 174 is substantially equal to the height “Y” of head 122 of screw 120. It will be seen from this figure that clip 130 is an integrally formed component. Clip 130 is again manufactured from very thin stainless steel. FIGS. 5&6 show that housing 170 also includes one or more axial slots 176 which extend from annular flange 172 through to lip 174. Slots 176 provide housing 170 with sufficient flexibility to allow it to snap-fit around head 122 of screw 120. Annular lip 174 extends slightly inwardly and consequently, when housing 170 is engaged with head 122, lip 174 retains head 122 within housing 170 (FIG. 7).

Retainer clip 130 is used in the following manner. When a dentist wishes to use an abutment screw 120, to install bridgework for instance, he grasps the screw 120 and secures the same into clip 130 by causing housing 170 to snap-fit over the head 122. This locks screw 120 and clip 130 together. He then brings the combined clip 130 and screw 120 into engagement with screwdriver 110. This is accomplished by inserting tip 118 of driver bit 116 into bore 138 and sliding clip 130 along shaft 114 toward body 112 of screwdriver 110. The interior surface of tubular member 132 of clip 130 frictionally engages the exterior surface of shaft 114. Clip 130 is slid along shaft 114 until the tip 118 of driver bit 116 is received within aperture 128 in head 122. The clip 130 can be rotationally manipulated to correctly orient the shaped tip 118 of bit 116 and the shaped aperture 128 of screw 120. Clip 130 therefore retains screw 120 and maintains the contact between screw 120 and driver bit 116. FIG. 7 shows that when fully engaged, clip 130 is shorter than the shaft 114 and driver tip 116 combined, so that clip 130 does not contact body 112. Clip 130 substantially maintains contact between driver bit 116 and screw 120.

The dentist positions the end 146 of screw 120 in an internally threaded bore of an implant that has been previously installed in the patient's jaw bone. The screwdriver 110 is used to rotate screw 120 until a sufficient portion of threads 126 have engaged the internal threads of the implant. Clip 130 thereby substantially prevents screw 120 from dislodging from driver bit 116 during this procedure and furthermore keeps head 122 of screw 120 in contact with driver bit 116. When a sufficient portion of threads 126 are engaged with the internal threads of the implant to prevent screw 120 from accidentally disengaging from the implant, the dentist can remove clip 130. This is accomplished by pulling screwdriver 110 upwardly to release clip 130 from its frictional engagement with shaft 114. This separates clip 130 from screwdriver 110, but leaves clip 130 attached to head 122 of screw 120. The clip 130 is then grasped and pulled upwardly to break housing 170 free of head 122. If needed, driver bit 116 may be engaged once again with head 122 of screw 120 to complete installation. Clip 130 may be sterilized and reused.

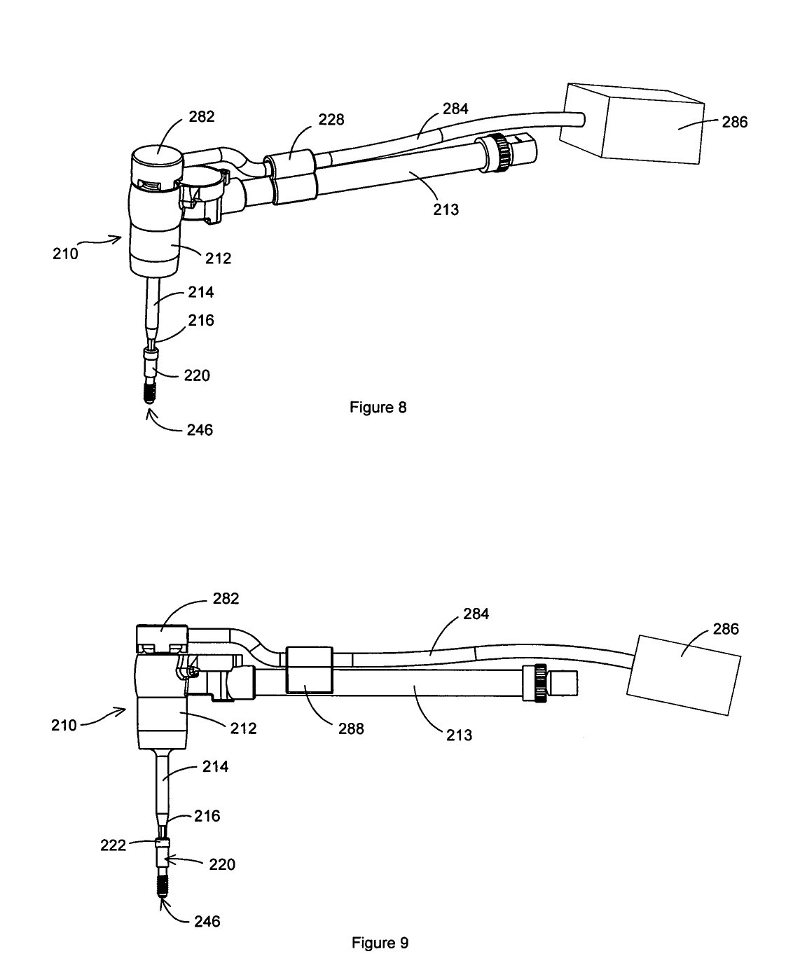

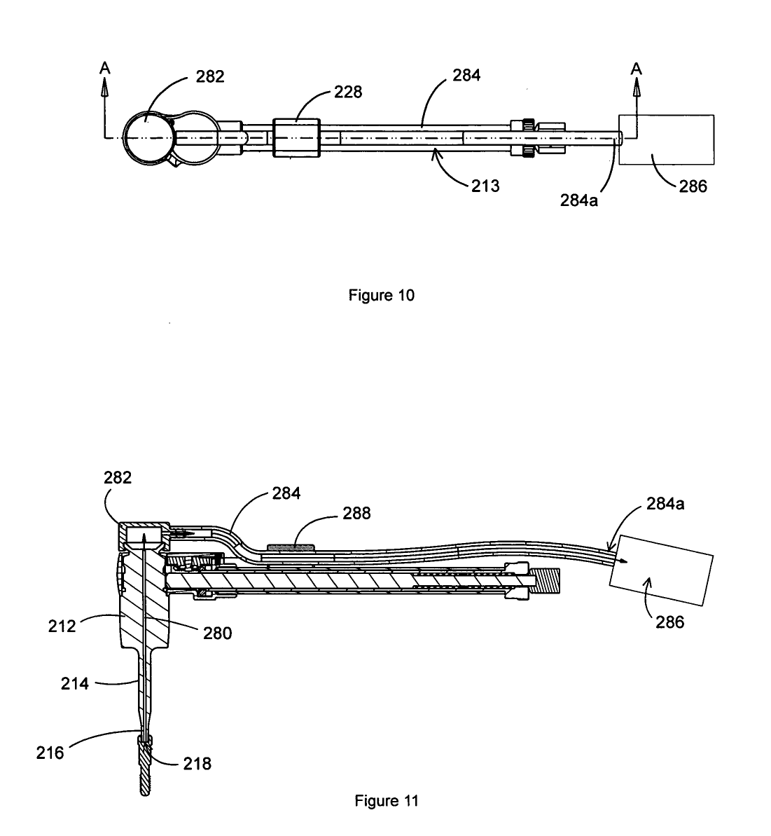

A third embodiment of a dental-component retainer is shown in FIGS. 8-11. In this instance, screwdriver 210 includes a body 212, a handle 213, a shaft 214 and a driver bit 216. The driver bit 216 has a tip 218 (FIG. 11) that is complementary shaped to engage a dental component. FIGS. 8-11 show that the dental component is an implant 220, but it will be understood that an abutment screw could also be retained in a similar manner without departing from the spirit of the present invention.

In accordance with a specific embodiment of the present invention, screwdriver 210 has been modified by the provision of a laser-drilled passageway 280 (FIG. 11) that extends through body 212, shaft 214 and driver bit 216. Passageway 280 terminates in an aperture in tip 218. A cap 282 is seated on screwdriver 210 so that passageway 280 is selectively connectable to a vacuum hose 284. Cap 282 preferably is manufactured from plastic and is snap-fitted to an upper portion of body 212. Vacuum hose 284 is connectable at a second end 284a to a standard vacuum source available in a dentist's office. The vacuum source is represented in these figures by the block 286. When activated, vacuum source 286 will evacuated air from hose 284 and passageway 280 and create a vacuum at the tip 218 of driver bit 216. Vacuum hose 284 preferably is secured to handle 213 by any suitable type of connector 288 so that hose 284 does not impede the dentist's performance.

When the dentist is installing implant 220 into a hole (not shown) in the jaw bone of a patient, he will activate vacuum source 286 to create a vacuum at tip 218 of driver bit 216. Head 222 of implant 220 is then brought into contact with tip 218 of driver bit 216. Implant 220 may be rotated to align the shaped tip 218 with the complementary shaped head 222 of implant 220. The vacuum created at tip 218 by vacuum source 286 will maintain the contact between implant 220 and driver bit 216 and will substantially prevent implant 220 from accidentally being dislodged from screwdriver 210. The dentist may then position the end 246 of implant 220 in the hole (not shown) in the patient's jaw bone and will use screwdriver 210 to screw implant 220 into place. Once sufficient threads 226 on implant 220 have been engaged in the jaw bone to prevent implant 220 from being accidentally dislodged therefrom, then the dentist can switch off the vacuum source 286. This restores atmospheric pressure at the tip 218 of driver bit 216 and the head 222 of implant 220 is no longer retained at the tip 218 of bit 216.

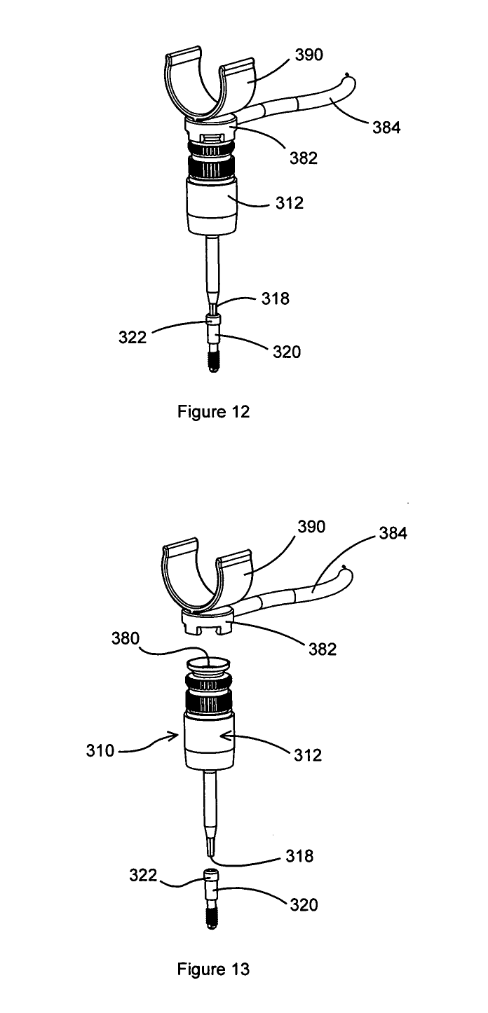

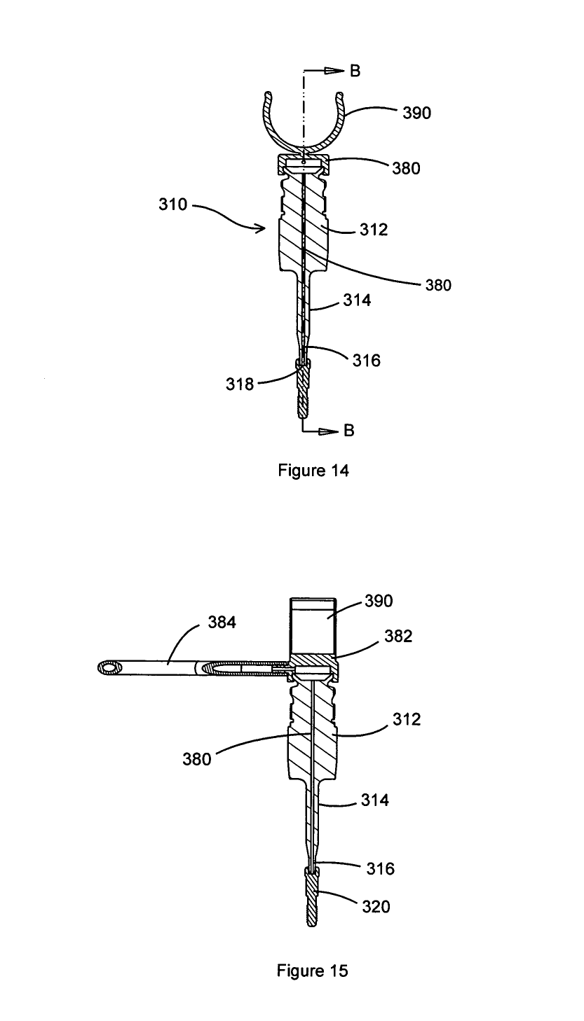

FIGS. 12-15 show a variation of the vacuum retainer used to maintain contact between an implant 320 and the driver bit 316 of screwdriver 310. In this instance, cap 382 is provided with a C-shaped finger clip 390. Finger clip 390 is sized and shaped to receive an index finger (not shown) therein. The vacuum hose 384 is connected to cap 382 and thereby to the passageway 380. Finger clip 390 provides for an easy way for the dentist to hold and control screwdriver 310.

It will be understood that any suitable type of threaded dental component may be used in conjunction with the retainer clip or vacuum system without departing from the spirit of the present invention.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. In combination:
a dental instrument having a shaft that includes a shaped driver bit at one end thereof;
a dental component:
a dental fastener for engaging the dental component for installation in the oral cavity of a patient; said dental fastener including:
a head that is configured to be engaged by the driver bit of the dental instrument;
a shank extending outwardly away from the head; and
a plurality of threads formed on a portion of the shank; and
a retainer clip for maintaining contact between the driver bit and the head of the dental fastener during at least partial installation of the dental component in the oral cavity of the patient; wherein said retainer clip has a first end, a second end and an interior surface therebetween: and wherein the interior surface frictionally engages the shaft of the dental instrument and the first end of the clip is free of contact with the shaft: and wherein the second end directly engages one of the head and shank of the dental fastener.

2. (canceled)

3. The combination of claim 1, wherein the clip includes an elongated tubular member that extends inwardly from said first end; and said interior surface defines an axial bore in said elongated tubular member; said bore being sized to frictionally receive a portion of the shaft of the dental instrument therethrough.

4. The combination of claim 3, wherein the second end of the clip comprises a housing that is complementary sized and shaped to receive the head of the dental component therein.

5. The combination of claim 4, wherein the housing snap fits around the head of the dental component.

6. The combination of claim 4, wherein the housing includes a side wall that is substantially concentric with the tubular member; and wherein the side wall has at least one axial slot therein that enables the side wall to flex to engage the head of the dental component.

7. The combination of claim 1, wherein the dental component is an abutment.

8. The combination of claim 1, wherein a tubular base having an axial bore sized to frictionally receive a portion of the shaft of the dental instrument therethrough extends inwardly from the first end of the clip; and the second end of the clip comprises a pair of flexible opposed legs extending axially outwardly away from the tubular base.

9. The combination of claim 8, wherein the head and shank of the dental fastener are substantially of the same diameter; and the flexible legs are spaced a distance apart from each other that is substantially equal to that diameter; and wherein the flexible legs frictionally receive the head and a portion of the shank therebetween.

10. The combination of claim 9, wherein the dental component is an implant bolt.

11. The combination of claim 1, wherein the dental instrument is provided with a passageway extending through the shaft and terminating in an aperture at a tip of the driver bit, and wherein the retention system comprises a vacuum system connected to said dental instrument; and
said vacuum system being activated to provide suction at the tip of the driver bit whereby the dental component is held in abutting contact with the tip of the driver bit.

12. The combination of claim 11, wherein the vacuum system includes:
a vacuum source;
a vacuum hose connected at a first end to the vacuum source;
a cap connected to a second end of the vacuum hose; said cap being selectively attachable to the dental instrument so that the vacuum source is operably connected to the passageway in the dental instrument.

13. The combination of claim 12, wherein the cap includes a C-shaped member; said C-shaped member being adapted to receive an index finger of a dentist therein.

14. A dental instrument comprising:
a shaft which terminates in a driver bit which is adapted to engage a complementary shaped head of a threaded dental fastener; and
a retention clip adapted to maintain contact between the driver bit and the head of the dental fastener during installation of the same; wherein the clip has a first end that is free of contact with the shaft; an interior surface that frictionally engages the shaft, and a second end that is adapted to directly engage the head of the fastener.

15. (canceled)

16. The dental instrument as defined in claim 14; wherein the clip includes an elongated tubular member extending inwardly from said first end; and said interior surface defines an axial bore that is sized to frictionally receive a portion of the shaft therein.

17. The dental instrument as defined in claim 16, wherein the second end of the clip comprises a housing that is of a larger diameter than the tubular member; said housing including at least one axial slot therein; said housing being adapted to snap fit around the head of the dental component.

18. The dental instrument as defined in claim 17, wherein the second end of the clip comprises a pair of spaced apart flexible fingers that extend axially outwardly away from the tubular member; said fingers being adapted to snap-fit around at least the head of the dental fastener.

19. The dental instrument as defined in claim 18, wherein at least a portion of the tubular member includes a longitudinal slot therein.

20. The dental instrument as defined in claim 14, further comprising a passageway extending through the shaft of the dental instrument and terminating in an aperture at a tip of the driver bit; and wherein the retention system comprises a vacuum system operationally connected to the passageway; whereby activation of the vacuum system creates a vacuum at the tip of the driver bit which maintains contact between the driver bit and the head of the dental component.

21. The combination of claim 1, wherein the clip defines an axial bore extending from the first end to the second thereof; and wherein the bore is of a substantially constant internal diameter.

22. The combination of claim 1, wherein the clip is a single, unitary component that is releasably engaged with the shaft of the dental instrument.

23. The combination of claim 1, wherein the clip further comprises an annular flange that extends outwardly away from the first end thereof.

24. The combination of claim 23, wherein the clip further comprises at least a second flange extending outwardly away from the second end thereof.

25. The combination of claim 1, wherein the dental instrument further comprises a handle operatively connected to the shaft thereof; and wherein the handle is disposed substantially at right angles to the shaft.

26. The combination of claim 1, wherein the clip is releasably engaged with the shaft of the dental instrument.

27. The dental instrument as defined in claim 14, wherein the clip defines an axial bore between the first and second ends thereof; and wherein the axial bore is of a substantially constant internal diameter.

28. The dental instrument as defined in claim 14, wherein the clip is a single, unitary component that is releasably engaged with the shaft.

29. The dental instrument as defined in claim 16, wherein the clip further comprises an annular flange that extends outwardly away from the first end thereof.

30. The dental instrument as defined in claim 29, wherein the clip further comprises at least a second flange extending outwardly away from the second end thereof.

31. The dental instrument as defined in claim 30, wherein the second end of the clip comprises a pair of spaced apart flexible fingers that extend longitudinally outwardly away from the tubular member; wherein said fingers each have an inner surface and an outer surface; and said inner surfaces are adapted to snap fit around the head of the dental fastener; and wherein the at least one second flange extends laterally outwardly away from the outer surface of one of said fingers.

32. The dental instrument as defined in claim 14, further comprising a handle operatively connected to the shaft of the instrument; and wherein the handle is disposed substantially at right angles to the shaft.

33. The dental instrument as defined in claim 14, wherein the clip is releasably engaged with the shaft of the dental instrument.
